(19) United States
(12) Patent Application Publication
(10) Pub. No.: US 2026/0111061 A1
(43) Pub. Date: Apr. 23, 2026

(54) ELECTRONIC DEVICE

(71) Applicant: InnoLux Corporation, Miao-Li County (TW)

(72) Inventors: Yuan-Lin WU, Miao-Li County (TW); Fu-Zhang KUO, Miao-Li County (TW); Chung-Wen YEN, Miao-Li County (TW)

(21) Appl. No.: 19/424,227

(22) Filed: Dec. 18, 2025

Related U.S. Application Data
(63) Continuation of application No. 18/064,407, filed on Dec. 12, 2022.

(30) Foreign Application Priority Data
Jan. 26, 2022 (CN) 202210093207.2

(51) Int. Cl. G06F 1/183; G09F 9/30

(52) U.S. Cl. CPC G06F 1/183; G09F 9/301

(57) ABSTRACT

An electronic device is provided. The electronic device includes a flexible panel, a supporting sheet disposed under the flexible panel, and a heat sink disposed under the supporting sheet. The flexible panel has a foldable region and a non-foldable region. The supporting sheet includes a foldable portion overlapping the foldable region, and the foldable portion includes a plurality of strip parts and a plurality of edge parts. Each of the edge parts is connected to an end of at least two of the strip parts, and in a top view, a top end of the edge parts is not aligned with a top end of at least one portion of the non-foldable region. The heat sink includes a gap and a separation portion adjacent to the gap, and in the non-folded state, one of the edge parts overlaps the gap of the heat sink.

### CROSS REFERENCE TO RELATED APPLICATIONS

This Application is a continuation of pending U.S. patent application Ser. No. 18/064,407, filed Dec. 12, 2022, which claims priority of China Patent Application No. 202210093207.2, filed on Jan. 26, 2022, the entirety of which is incorporated by reference herein.

### BACKGROUND

### Field of the Disclosure

The present disclosure relates to an electronic device, and in particular to an electronic device including a flexible panel and a supporting sheet having a specific structure for supporting the flexible panel.

### Description of the Related Art

Thanks to technological developments, the use of electronic devices is very common nowadays. Electronic devices with display functions in particular have been adopted in various fields. However, consumers have higher and higher standards for the appearance of their display devices, and tend to prefer smaller, more compact models over bulky ones. Therefore, foldable electronic devices are currently being developed to reduce the dimensions of such electronic devices. There is still room for improvement in the durability of such foldable electronic devices, however. Accordingly, how to solve the above problem is an important issue.

### BRIEF SUMMARY

Some embodiments of the disclosure provide an electronic device. The electronic device includes a flexible panel, a supporting sheet, and a heat sink. The flexible panel has a foldable region and a non-foldable region, and the foldable region has a folding axis. The supporting sheet is disposed under the flexible panel and includes a foldable portion. The foldable portion overlaps the foldable region, and the foldable portion includes a plurality of strip parts and a plurality of edge parts. The strip parts are arranged in a first direction perpendicular to the folding axis. Each of the edge parts is connected to an end of at least two of the strip parts, and in a top view, a top end of the edge parts is not aligned with a top end of at least one portion of the non-foldable region. The heat sink is disposed under the supporting sheet, and includes a gap and a separation portion adjacent to the gap. In the non-folded state, one of the edge parts overlaps the gap of the heat sink.

In order to make the above-mentioned and other purposes, features and advantages of the present disclosure more obvious and easy to understand, some embodiments are given below, and are described in detail as follows in conjunction with the accompanying drawings.

### BRIEF DESCRIPTION OF THE DRAWINGS

The present disclosure can be more fully understood by reading the subsequent detailed description and examples with references made to the accompanying drawings, wherein:

FIG. 1 shows a top view of an electronic device in accordance with some embodiments of the present disclosure.

FIG. 2 shows a top view of the supporting sheet in the region A shown in FIG. 1 in accordance with some embodiments of the present disclosure.

FIG. 3 shows a partial enlarged view of a foldable portion in accordance with some embodiments of the present disclosure.

FIG. 4 and FIG. 5 show top views of the supporting sheet in the region A shown in FIG. 1 in accordance with some comparative examples of the present disclosure.

FIG. 6 shows a diagram of the relationship between the damage probability of the supporting sheet and the ratio of the first length to the first width in accordance with some embodiments of the present disclosure.

FIG. 7 and FIG. 8 show top views of the supporting sheet in the region A shown in FIG. 1 in accordance with some comparative examples of the present disclosure.

FIG. 9 shows a diagram of the relationship between the damage probability of the supporting sheet and the ratio of the first width to the spacing between the edges in accordance with some embodiments of the present disclosure.

FIG. 10 shows a partial enlarged view of a supporting sheet in accordance with some embodiments of the present disclosure.

FIGS. 11 and 12 shows top views of the supporting sheet in the region A shown in FIG. 1 in accordance with some comparative examples of the present disclosure.

FIG. 13 shows a diagram of the relationship between the damage probability of the supporting sheet and the ratio of the first length to the second length in accordance with some embodiments of the present disclosure.

FIG. 14 shows a partial enlarged view of the supporting sheet in accordance with some embodiments of the present disclosure.

FIG. 15 shows a partial cross-sectional view of the electronic device in accordance with some embodiments of the present disclosure.

FIG. 16 shows a partial cross-sectional view of the electronic device in accordance with some embodiments of the present disclosure.

FIG. 17 shows a partial cross-sectional view of the electronic device in accordance with some embodiments of the present disclosure.

FIG. 18 shows a partial cross-sectional view of the electronic device in accordance with some embodiments of the present disclosure.

### DETAILED DESCRIPTION

The present disclosure may be understood by referring to the following description and the appended drawings. It should be noted that, in order to make the reader easy to understand and make the drawings concise, the drawings in the present disclosure may illustrate a part of the light-emitting unit, and specific elements in the drawings are not drawn based on the actual scale. In addition, the number and the size of each component in the drawings merely serves as an example, and are not intended to limit the scope of the present disclosure. Furthermore, similar and/or corresponding numerals may be used in different embodiments for describing some embodiments simply and clearly, but not represent any relationship between different embodiment and/or structures discussed below.

Certain terms may be used throughout the present disclosure and the appended claims to refer to particular elements. Those skilled in the art will understand that electronic device manufacturers may refer to the same components by different names. The present specification is not intended to distinguish between components that have the same function but different names. In the following specification and claims, the words “including”, “comprising”, “having” and the like are open words, so they should be interpreted as meaning “including but not limited to . . . ”. Therefore, when terms “including”, “comprising”, and/or “having” are used in the description of the disclosure, the presence of corresponding features, regions, steps, operations and/or components is specified without excluding the presence of one or more other features, regions, steps, operations and/or components.

In addition, in this specification, relative expressions may be used. For example, “lower”, “bottom”, “higher” or “top” are used to describe the position of one element relative to another. It should be noted that if a device is flipped upside down, an element that is “lower” will become an element that is “higher”.

When a corresponding component (such as a film layer or region) is referred to as “on another component”, it may be directly on another component, or there may be other components in between. On the other hand, when a component is referred “directly on another component”, there is no component between the former two. In addition, when a component is referred “on another component”, the two components have an up-down relationship in the top view, and this component can be above or below the other component, and this up-down relationship depends on the orientation of the device.

It should be understood that, although the terms “first”, “second” etc. may be used herein to describe various elements, regions, layers and/or portions, and these elements, regions, layers, and/or portions should not be limited by these terms. These terms are only used to distinguish one element, component, region, layer, or portion. Thus, a first element, component, region, layer or portion discussed below could be termed a second element, component, region, layer or portion without departing from the teachings of some embodiments of the present disclosure. In addition, for the sake of brevity, terms such as “first” and “second” may not be used in the description to distinguish different elements. As long as it does not depart from the scope defined by the appended claims, the first element and/or the second element described in the appended claims can be interpreted as any element that meets the description in the specification.

In the present disclosure, the thickness, length, and width can be measured by using an optical microscope, and the thickness can be measured by the cross-sectional image in the electron microscope, but it is not limited thereto. In addition, a certain error may be present in a comparison with any two values or directions. The terms “about,” “equal to,” “equivalent,” “the same,” “essentially” or “substantially” are generally interpreted as within 20% of a given value or range, or as interpreted as within 10%, 5%, 3%, 2%, 1%, or 0.5% of a given value or range.

It should be noted that the technical solutions provided by different embodiments below may be interchangeable, combined or mixed to form another embodiment without departing from the spirit of the present disclosure.

Unless defined otherwise, all terms (including technical and scientific terms) used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined in the present disclosure.

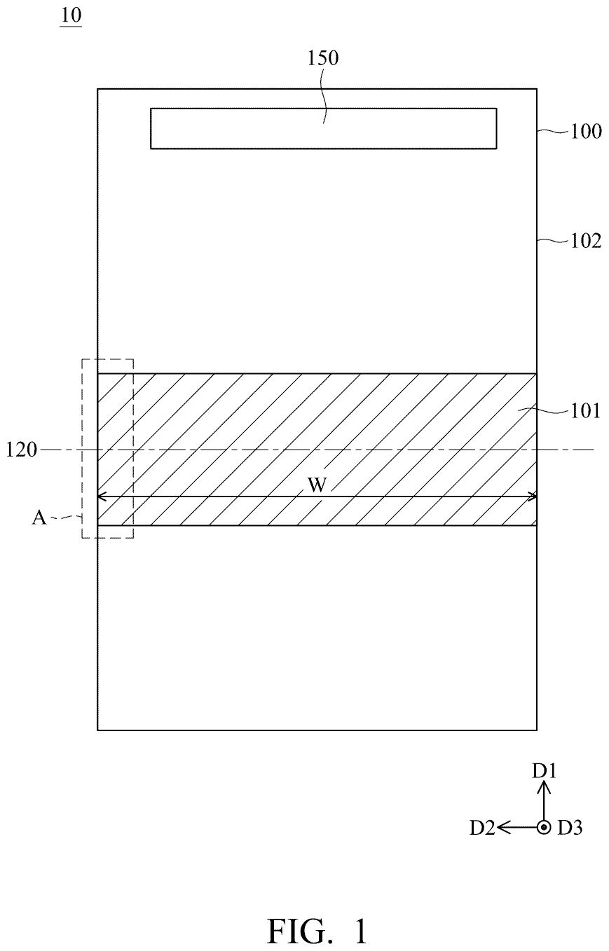

FIG. 1 shows a top view of an electronic device 10 in accordance with some embodiments of the present disclosure. It should be noted that the electronic device 10 may include a display device, a backlight device, an antenna device, a sensing device, or a tiled device, bur the present disclosure is not limited thereto. The electronic device 10 may be a bendable electronic device or a flexible electronic device. The display device may be a non-self-luminous display device or a self-luminous display device. The antenna device may be a liquid crystal antenna device or a non-liquid crystal antenna device, and the sensing device may be a sensing device for sensing capacitance, light, thermal energy or ultrasonic waves, but the present disclosure is not limited thereto. In some embodiments, the electronic device 10 includes a flexible panel including electronic components, which may include passive components and active components, such as capacitors, resistors, inductors, diodes, transistors, and the like. In some embodiments, the diodes may comprise light-emitting diodes or photodiodes. The light-emitting diodes may include, for example, organic light-emitting diodes (OLEDs), mini light-emitting diodes (mini LEDs), micro light-emitting diodes (micro LEDs), or quantum dot light-emitting diodes (quantum dot LEDs), but the present disclosure is not limited thereto. The tiled device may be, for example, a display tiled device or an antenna tiled device, but the present disclosure is not limited thereto. It should be noted that, the electronic device 10 can be any combination of the aforementioned devices, but the present disclosure is not limited thereto. The following paragraphs will take the partial structure of the electronic device 10 as an example to illustrate the content of the present disclosure. Those skilled in the art should understand that the electronic device 10 may also include other structures to perform the intended functions.

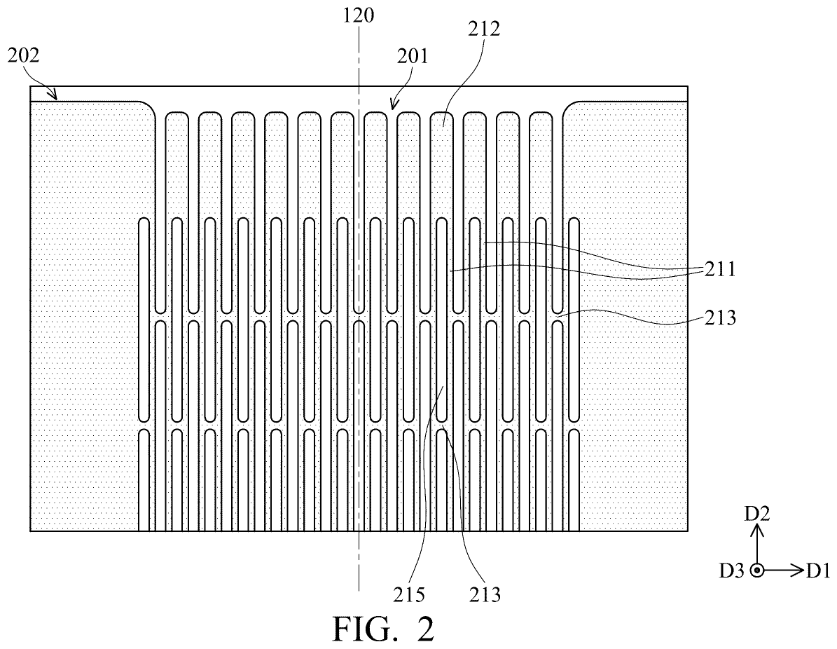

Referring to FIG. 1 and FIG. 2, as shown in FIG. 1, the electronic device 10 may include a flexible panel 100 and a supporting sheet 200 (for example, shown in FIG. 2) that is disposed below the flexible panel 100. The flexible panel 100 includes a foldable region 101 and a non-foldable region 102 that is adjacent to the foldable region 101. In some embodiments, the foldable region 101 has a folding axis 120 that passes through the foldable region 101, and the flexible panel 100 is foldable by using the folding axis 120 as a central axis. It should be noted that the flexible panel 100 may be a flexible display panel, a flexible sensing panel, a flexible antenna panel, but it is not limited thereto. The material of the supporting sheet 200 may be metal materials such as steel, copper, aluminum, iron, or other non-metallic materials that are both malleable and supportive.

In the present embodiment, a first direction D1, a second direction D2, and a third direction D3 that are substantially perpendicular to each other are defined for the ease of the description of the orientation of each part in the electronic device 10 of the present disclosure. For example, the second direction D2 may be substantially parallel to the folding axis 120, the first direction D1 may be substantially perpendicular to the folding axis 120, and the third direction D3 may be substantially perpendicular to the first direction D1 and the second direction D2. In some embodiments, the foldable region 101 may have a width W that is measured in the second direction D2. In addition, an electronic component 150 may also be optionally disposed on the flexible panel 100. For example, the electronic device 150 may be, for example, an integrated circuit or any of the electronic components listed in the above paragraphs, so as to perform the functions designed for the electronic device 10. It should be understood that, in other embodiments, the electronic component 150 may be omitted, or the electronic component 150 may be arranged at other positions or bent to the backside of the supporting sheet 200. Not all possible embodiments will be listed below, but these possible embodiments are included within the scope of the present disclosure.

FIG. 2 shows a top view of the supporting sheet 200 in the region A shown in FIG. 1 in accordance with some embodiments of the present disclosure. As shown in FIG. 2, the supporting sheet 200 may include a foldable portion 201 and a non-foldable portion 202 that is adjacent to the foldable portion 201. In some embodiments, the foldable portion 201 may substantially overlap the foldable region 101 (in the top view). The foldable portion 201 may include a plurality of strip parts 211, a plurality of edge parts 212 and a plurality of connecting parts 213. The strip parts 211 may be arranged in the first direction D1 that is substantially perpendicular to the folding axis 120. In other words, the strip parts 211 may be substantially parallel to each other and extend in the second direction D2 that is parallel to the folding axis 120. In some embodiments, the strips parts 211 may be spaced from each other by a substantially equal distance, but the present disclosure is not limited thereto. Each of the edge parts 212 connects the ends of at least two strip parts 211 (more specifically, the ends of at least two adjacent strip parts 211). One of the connecting parts 213 connects two adjacent strip parts 211. In some embodiments, the strip parts 211, the edge part 212 and the connecting part 213 may be connected to each other and form a hole 215, that is, two adjacent strip parts 211, the edge part 212 and the connecting part 213 may surround the hole 215. In some embodiments, the number of edge parts 212 between the non-foldable portions 202 may be greater than or equal to 10 and less than or equal to 20 (10≤the number of edge parts≤20), but the present disclosure is not limited thereto. With the above features, the electronic device 10 is foldable more smoothly, or the electronic device 10 may be folded to have a specific arc or any other desired shape.

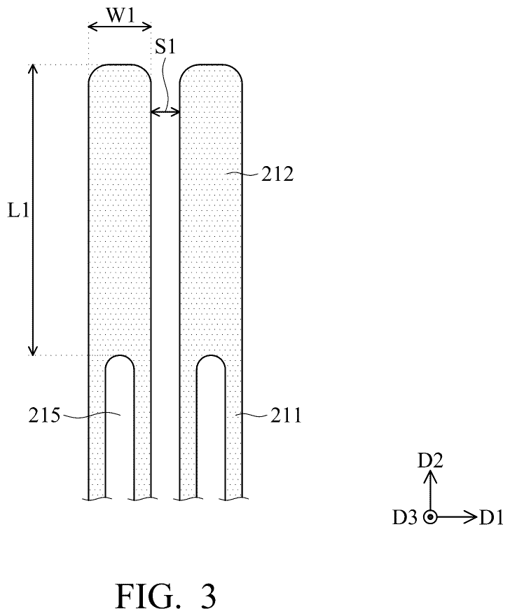

FIG. 3 shows a partial enlarged view of the foldable portion 201 in accordance with some embodiments of the present disclosure. As shown in FIG. 3, the edge parts 212 of the foldable portion 201 may be spaced apart from each other, and the distance between the adjacent edge parts 212 may be defined as a distance S1. In some embodiments, the distance S1 may be the shortest distance between the adjacent edge parts 212 in the first direction D1, but the present disclosure is not limited thereto. For example, the distance S1 may be greater than or equal to 0.05 millimeters (mm) and less than or equal to 0.5 mm (0.05 mm≤S1≤0.5 mm). In addition, the edge parts 212 may have a first length L1 and a first width W1. For example, the first length L1 may be measured in the second direction D2 from the vertex of the hole 215 to the opposite vertex of the edge parts 212, and the first width W1 may be the maximum distance of the edge parts 212 in the first direction D1. In some embodiments, the first width W1 may be greater than or equal to 0.1 millimeter (mm) and less than or equal to 0.5 mm (0.1 mm≤W1≤0.5 mm), and the first length L1 may be greater than or equal to 1 millimeter (mm) and less than or equal to 3 mm (1 mm≤L1≤3 mm), but the present disclosure is not limited thereto.

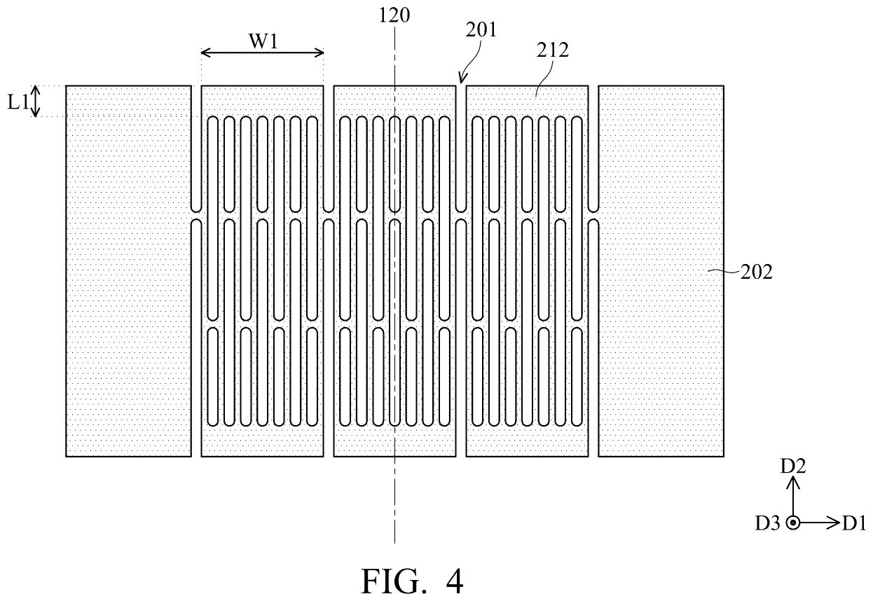

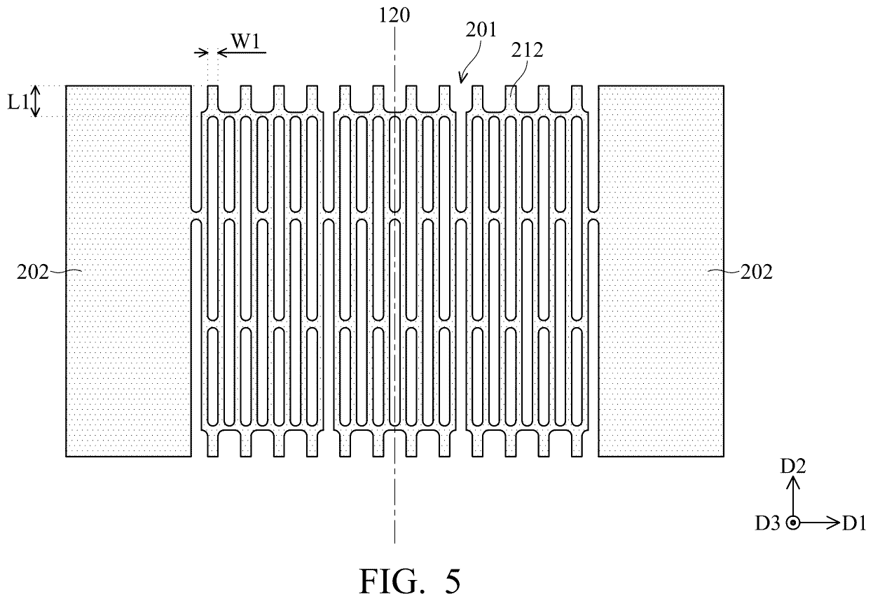

Referring to FIG. 4 to FIG. 6, FIGS. 4 and 5 show top views of the supporting sheet 200 in the region A shown in FIG. 1 in accordance with some comparative examples of the present disclosure. As shown in FIG. 4, in this comparative example, the first width W1 of the edge parts 212 is wider and more ends of the strip parts are connected by the edge part 212 at the same time. However, under this structure, permanent deformation is likely to occur after folding, and the supporting sheet 200 is unable to return to its original state. As shown in FIG. 5, in this comparative example, the ratio of the first length L1 to the first width W1 of the edge parts 212 is relatively large, so that the appearance of the edge parts 212 appears slender. However, under this structure, the edge parts 212 may tend to be damaged after folding.

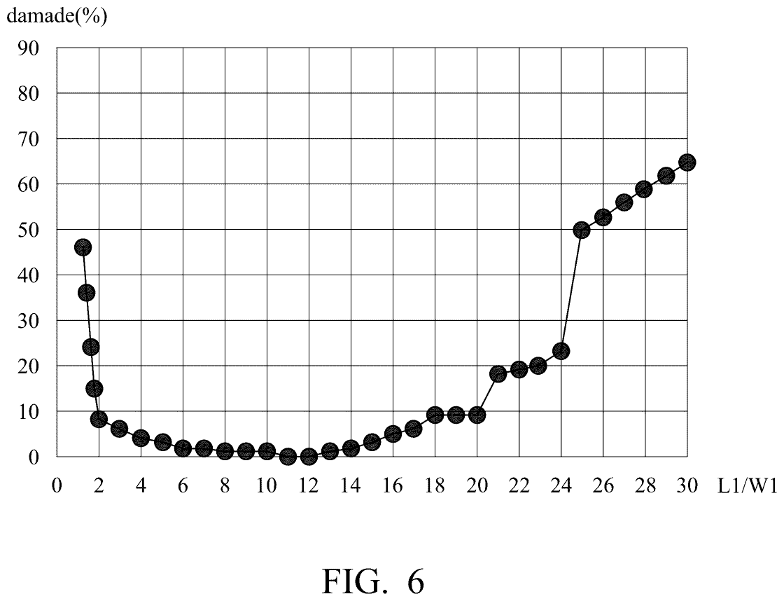

FIG. 6 shows a diagram of the relationship between the damage probability of the supporting sheet 200 and the ratio of the first length L1 to the first width W1 in accordance with some embodiments of the present disclosure. It should be noted that this relationship diagram simulates the damage probability of the supporting sheet 200 after being folded 10,000 times. As shown in FIG. 6, the damage probability of the supporting sheet 200 is simulated when the ratio of the first length L1 to the first width W1 is greater than or equal to 1.2 and less than or equal to 30. Based on the results of the above simulation, when the ratio of the first length L1 to the first width W1 is greater than or equal to 2 and less than or equal to 20, the damage probability of the supporting sheet 200 may be lower than 10%. When the ratio of the first length L1 to the first width W1 is greater than or equal to 4 and less than or equal to 15, the damage probability of the supporting sheet 200 may be lower than 5%. Therefore, in some embodiments, the ratio of the first length L1 to the first width W1 may be greater than 2 (L1/W>2). For example, the ratio of the first length L1 to the first width W1 may be greater than 2 and less than or equal to 20 (2<L1/W1≤20). In some embodiments, the ratio of the first length L1 to the first width W1 may be greater than or equal to 4 and less than or equal to 15 (4≤L1/W1≤15). In some embodiments, the ratio of the first length L1 to the first width W1 may be greater than or equal to 6 and less than or equal to 12 (6≤L1/W1≤12), but the above numerical ranges are merely examples, not to limit the scope of the present disclosure. The above features may improve the ease of folding, or may reduce the probability of the permanent deformation of the supporting sheet 200 due to the excessively wide first width W1 of the edge parts 212 or reduce the damage probability due to the excessively narrow first width W1 of the edge parts 212, thereby prolonging the service life of the supporting sheet 200.

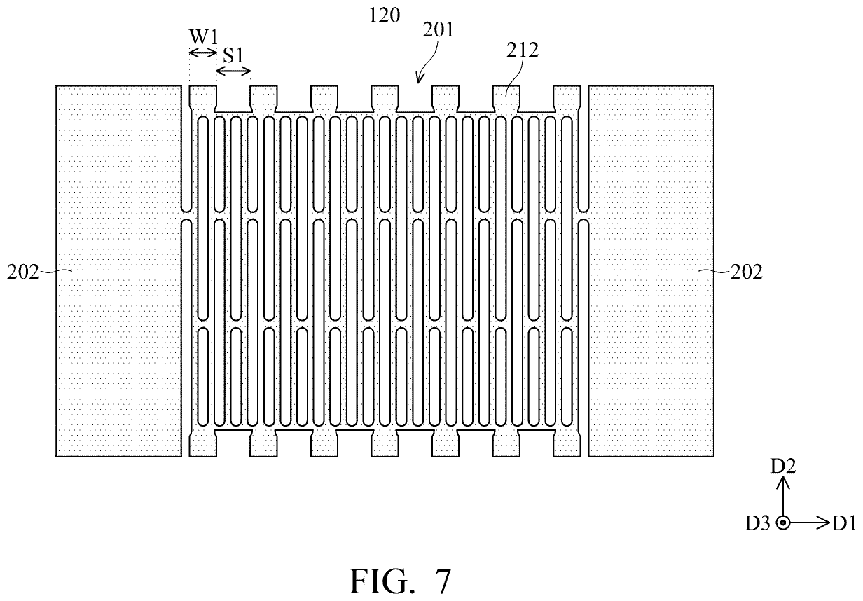

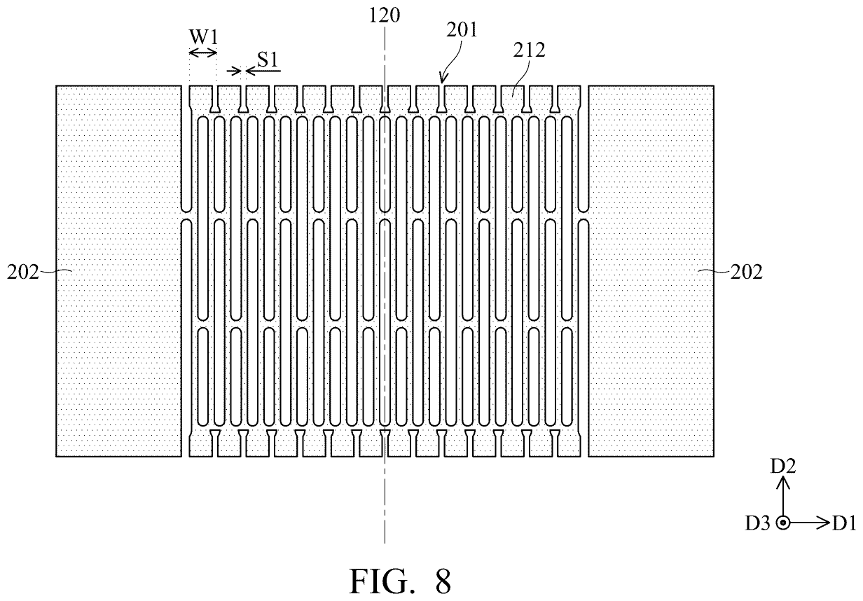

Referring to FIG. 7 to FIG. 9, FIGS. 7 and 8 show top views of the supporting sheet 200 in the region A shown in FIG. 1 in accordance with some comparative examples of the present disclosure. As shown in FIG. 7, in this comparative example, the edge parts 212 are far apart from each other so that the ratio of the first width W1 to the distance S1 is relatively small. However, when the edge parts 212 are too far apart from each other, the edge parts 212 may not be effectively strengthened, so that the supporting sheet 200 tends to be broken between the edge parts 212. As shown in FIG. 8, in this comparative example, the ratio of the first width W1 to the distance S1 increases due to the dense arrangement of the edge parts 212. However, when the distance between the edge parts 212 is too small, the edge parts 212 tend to rub against each other during folding, causing deformation.

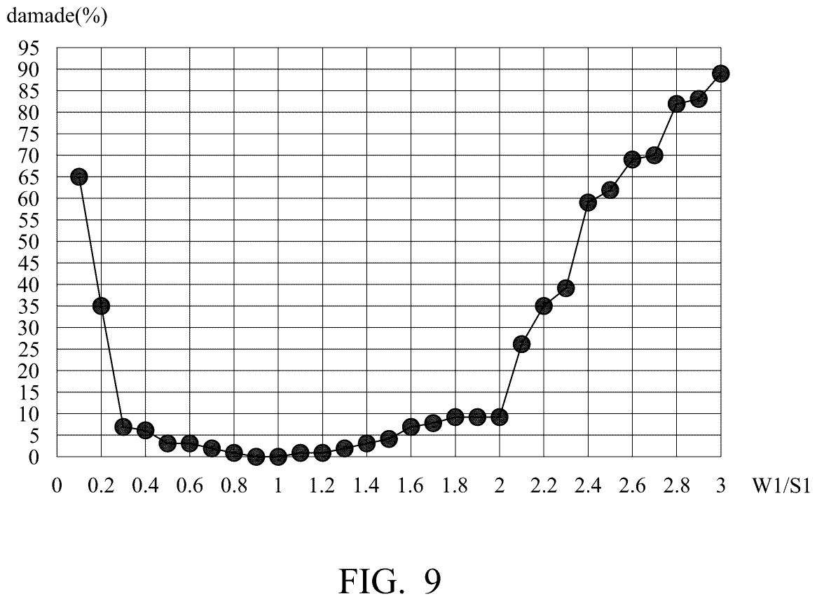

FIG. 9 shows a diagram of the relationship between the damage probability of the supporting sheet 200 and the ratio of the first width W1 to the distance S1 in accordance with some embodiments of the present disclosure. It should be noted that this relationship diagram simulates the damage probability of the supporting sheet 200 after being folded 10,000 times. As shown in FIG. 9, the damage probability of the supporting sheet 200 is simulated when the ratio of the first width W1 to the distance S1 is greater than or equal to 0.1 and less than or equal to 3. Based on the results of the above simulation, when the ratio of the first width W1 to the distance S1 is greater than or equal to 0.3 and less than or equal to 2, the damage probability of the supporting sheet 200 may be lower than 10%. When the ratio of the first width W1 to the distance S1 is greater than or equal to 0.5 and less than or equal to 1.5, the damage probability of the supporting sheet 200 may be lower than 5%. Therefore, for example, in some embodiments, the ratio of the first width W1 of the edge parts 212 to the distance S1 between the adjacent edge parts 212 may be greater than or equal to 0.3 and less than or equal to 2 (0.3≤W1/S1≤2). In some embodiments, the ratio of the first width W1 of the edge parts 212 to the distance S1 between the adjacent edge parts 212 may be greater than or equal to 0.5 and less than or equal to 1.5 (0.5≤W1/S1≤1.5). The above features help increase the structural strength of the edge parts 212, or reduce the probability of deformation and damage due to the rubbing of the edge parts 212, thereby prolonging the service life of the supporting sheet 200. In addition, the width W of the foldable region must be set in an appropriate range in consideration of the overall thickness of the electronic device after bending. For example, in some embodiments, the ratio of the first length L1 to the width W of the foldable region is greater than or equal to 0.01 and less than or equal to 0.05 (0.01≤L1/W≤0.05), but the present disclosure is not limited thereto.

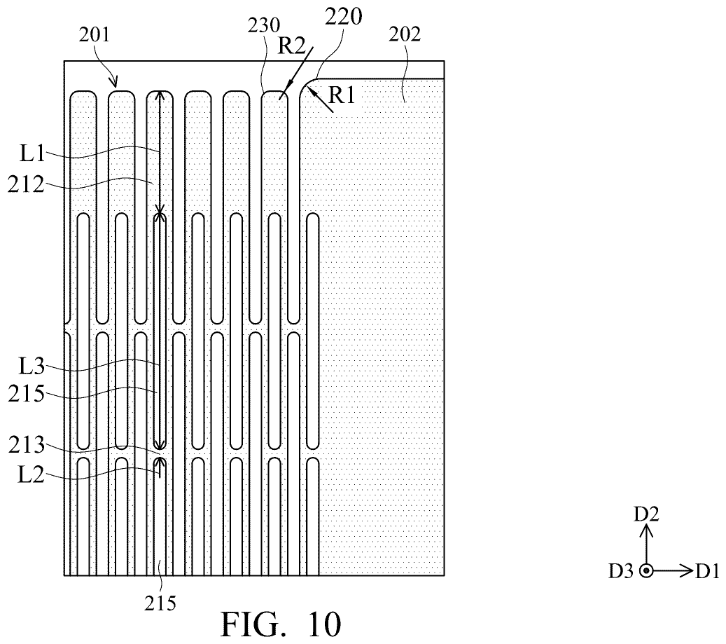

FIG. 10 shows a partial enlarged schematic view of the supporting sheet 200 in accordance with some embodiments of the present disclosure. As shown in FIG. 10, the connecting part 213 may have a second length L2, and the hole 215 may have a third length L3. For example, the second length L2 may be the shortest length of the connecting parts 213 in the second direction D2, and the second length L2 may be the shortest distance between the two adjacent holes 215 that are separated by the connecting part 213 in the second direction D2. In addition, the third length L3 may be the maximum length of the hole 215 in the second direction D2. That is, the third length L3 may be measured from the uppermost vertex of the hole 215 to the lowermost vertex of the hole 215. In some embodiments, the third length L3 may be greater than or equal to 2 mm and less than or equal to 6 mm (2 mm≤L3≤6 mm), but not limited thereto. In some embodiments, the ratio of the first length L1 of the edge parts 212 to the third length L3 of the hole 215 is greater than or equal to 0.3 and less than or equal to 0.6 (0.3≤L1/L3≤0.6).

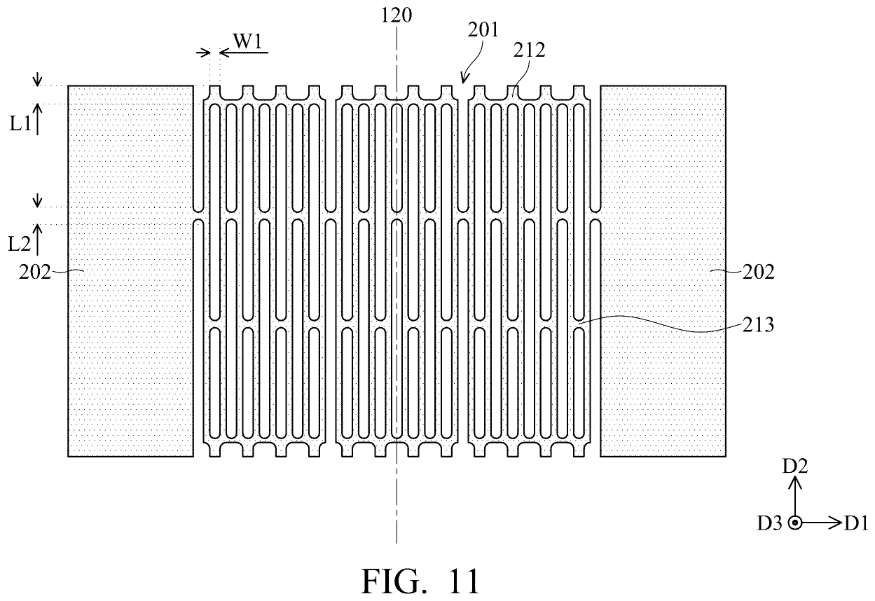

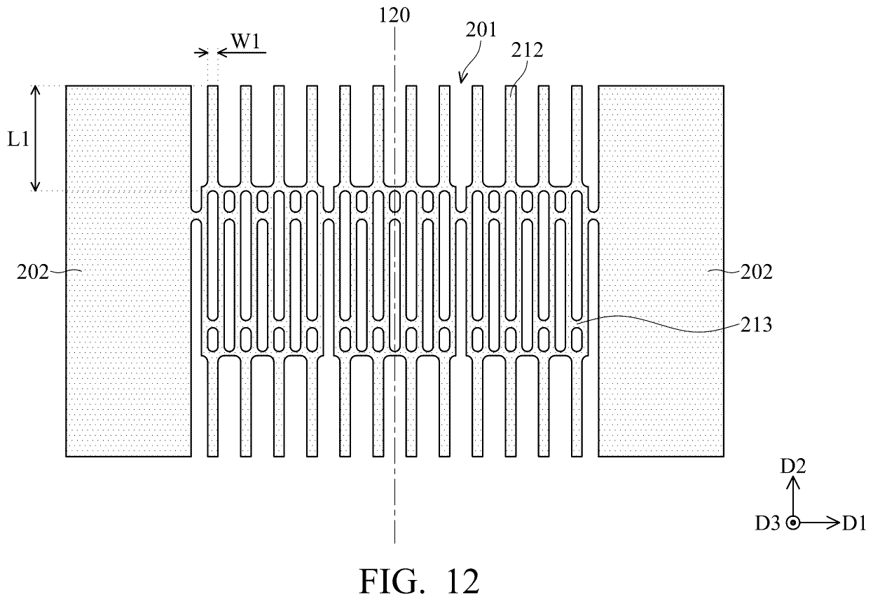

Referring to FIG. 11 to FIG. 13, FIG. 11 and FIG. 12 show top views of the supporting sheet 200 in the region A shown in FIG. 1 in accordance with some comparative examples of the present disclosure. As shown in FIG. 11, in this comparative example, the first length L1 of the edge parts 212 is relatively short, so that the ratio of the first length L1 of the edge parts 212 to the second length L2 of the connecting parts 213 is relatively small. However, under this structure, the edge parts 212 tend to be deformed and fractured. As shown in FIG. 12, in this comparative example, the first length L1 of the edge parts 212 is relatively long, so that the ratio of the first length L1 of the edge parts 212 to the second length L2 of the connecting parts 213 is relatively large. However, under this structure, the center of the supporting sheet 200 tend to be pulled and deformed.

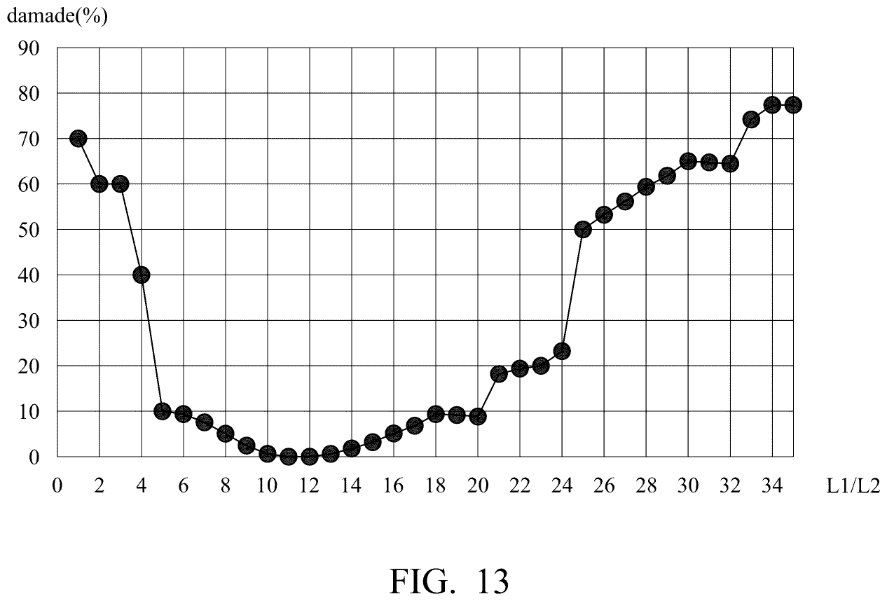

FIG. 13 shows a diagram of the relationship between the damage probability of the supporting sheet 200 and the ratio of the first length L1 to the second length L2 in accordance with some embodiments of the present disclosure. It should be noted that this relationship diagram simulates the damage probability of the supporting sheet 200 after being folded 10,000 times. As shown in FIG. 13, the damage probability of the supporting sheet 200 is simulated when the ratio of the first length L1 to the second length L2 is greater than or equal to 1 and less than or equal to 100. Based on the results of the above simulation, when the ratio of the first length L1 to the second length L2 is greater than or equal to 5 and less than or equal to 20, the damage probability of the supporting sheet 200 may be lower than 10%. When the ratio of the first length L1 to the second length L2 is greater than or equal to 8 and less than or equal to 15, the damage probability of the supporting sheet 200 may be less than 5%. Therefore, in some embodiments, the first length L1 of the edge parts 212 is greater than the second length L2 of the connecting parts 213. For example, the ratio of the first length L1 to the second length L2 may be greater than or equal to 5 and less than or equal to 20 (5≤L1/L2≤20). In some embodiments, the ratio of the first length L1 to the second length L2 may be greater than or equal to 8 and less than or equal to 15 (8≤L1/L2≤15), but the above numerical range is merely an example, not to limit the scope of the present disclosure. The above features may help to improve the structural strength of the supporting sheet 200 and reduce the probability of permanent deformation or damage caused by the excessively long first length L1 of the edge parts 212 after the supporting sheet 200 is folded for many times, thereby prolonging the service life of the supporting sheet 200.

Referring to FIG. 10, as shown in FIG. 10, in some embodiments, the non-foldable portion 202 may have a first rounded corner 220 that is adjacent to (i.e., toward) the edge parts 212. The edge parts 212 may have a second rounded corner 230 that is adjacent to the first rounded corner 220. The first rounded corner 220 may have a radius of curvature R1, the second rounded corner 230 may have a radius of curvature R2, and the radius of curvature R2 is smaller than the radius of curvature R1. For example, the radius of curvature R1 of the first rounded corner 220 may be greater than or equal to 0.05 mm and less than or equal to 0.5 mm (0.05 mm≤R1≤0.5 mm). The radius of curvature R2 of the second rounded corner 230 may be greater than or equal to 0.03 mm and less than or equal to 0.1 mm (0.03 mm≤R2≤0.1 mm). The feature regarding the rounded corner of the non-foldable portion 202 and the edge parts 212 may reduce the probability of scratching the flexible panel 100 by the supporting sheet 200 during folding. In addition, the non-foldable portion 202 having higher structural strength may protect the foldable portion 201 by setting the specific size relationship between the above-mentioned rounded corners, reducing the damage probability of the foldable portion 201 caused by collision, thereby prolonging the service life of the supporting sheet 200.

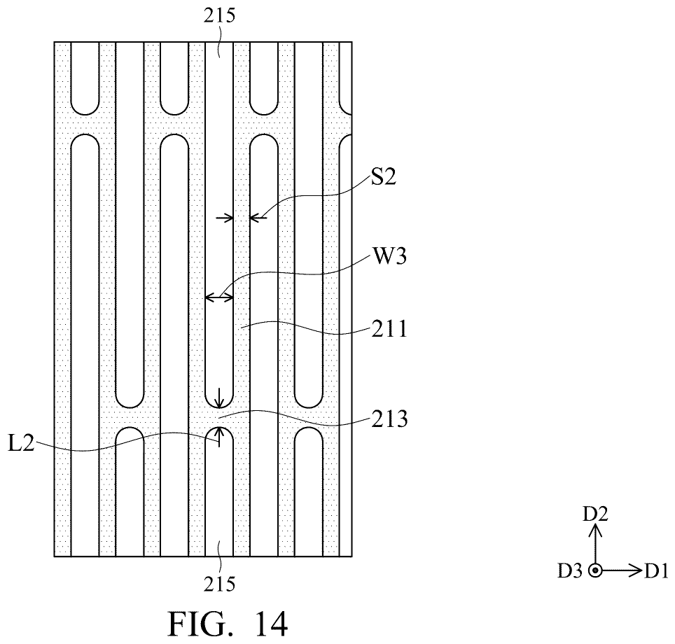

FIG. 14 shows a partially enlarged view of the supporting sheet 200 in accordance with some embodiments of the present disclosure. As shown in FIG. 14, the hole 215 has a width W3 in the first direction D1 which is perpendicular to the folding axis 120, and the strip parts 211 have a width S2 in the first direction D1 which is perpendicular to the folding axis 120. For example, the width W3 may be the maximum width of the hole 215 in the first direction D1, and the width S2 may be the minimum width of the strip parts 211 in the first direction D1. For example, the width W3 may be greater than or equal to 0.1 mm and less than or equal to 0.3 mm (0.1 mm≤W3≤0.3 mm). In some embodiments, the width S2 may be the shortest distance between the holes 215 located on both sides of the strip parts 211 in the first direction D1 which is perpendicular to the folding axis 120, so that the width S2 may also be defined as the spacing S2 between the holes 215. In some embodiments, the width W3 of the hole 215 is greater than the width S2 of the strip parts 211. In some embodiments, the second length L2 of the connecting parts 213 is greater than the width S2 of the strip parts 211. With the above features, the supporting sheet 200 may tend to be folded about the folding axis 120. In addition, the hole 215 may be provided with a rounded corner at the edge. With the above features, the risk that the foldable portion 201 cracks may be reduced, or the supporting strength of the foldable portion 201 may be improved.

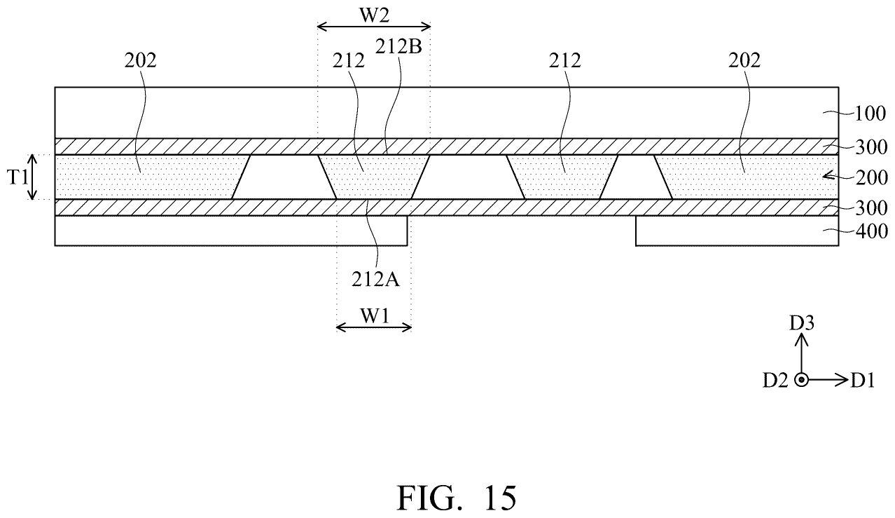

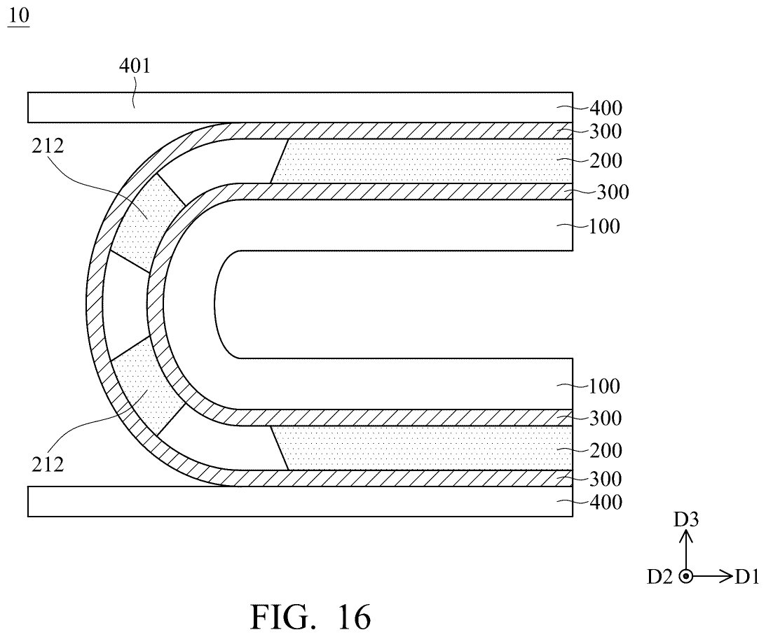

Referring to FIG. 15 and FIG. 16, FIG. 15 shows a partial cross-sectional view of the electronic device 10 in accordance with some embodiments of the present disclosure. It should be noted that the present embodiment illustrates a simplified structure of the electronic device 10 for the ease of description, which does not indicate that the actual electronic device 10 must have the same structure as this embodiment. Those skilled in the art should be able to understand the complete structure of the electronic device 10 according to the contents of the description and drawings of the present disclosure, and the detailed structure will not be discussed below. As shown in FIG. 15, the electronic device 10 may further include an adhesive layer 300 that is disposed between the flexible panel 100 and the supporting sheet 200 for bonding the flexible panel 100 and the supporting sheet 200. In some embodiments, the adhesive layer 300 may be disposed across the plurality of edge parts 212 and the non-foldable portions 202 in, for example, the first direction D1, but the present disclosure is not limited thereto. In this way, the assembling process of the electronic device 10 may be simplified. In other embodiments, the adhesive layer 300 may be disposed corresponding to the positions of the edge parts 212 and the non-foldable portion 202. As a result, the efficiency of material usage may be increased.

In addition, the electronic device 10 may further include a heat sink 400 that is, for example, disposed on the supporting sheet 200 and bonded to the supporting sheet 200 via the adhesive layer 300. The heat sink 400 may improve the heat dissipation efficiency of the electronic device 10 and reduce the probability of failure and damage of the electronic device 10. In some embodiments, a specific treatment may be performed to the adhesive layer 300 so that some local areas of the adhesive layer 300 are not adhesive. The above-mentioned treatment may include a gas treatment process, such as an ashing process, etc., but the present disclosure is not limited thereto. In some embodiments, the supporting sheet 200 may have a thickness T1 in the third direction D3, and the thickness T1 may be greater than or equal to 0.1 mm and less than or equal to 0.2 mm (0.1 mm≤T1≤0.2 mm), but the present disclosure is not limited thereto. In this way, the volume of the hole 215 may be greater than or equal to 0.05 mm³ and less than or equal to 0.3 mm³ (0.05 mm³≤the volume of the hole≤0.3 mm ³). With the above features, the probability of the supporting sheet 200 being deformed due to multiple folds may be reduced, or the manufacturing difficulty of the supporting sheet 200 may be reduced, so as to reduce the risk of the supporting sheet 200 breaking.

In some embodiments, the edge parts 212 has a first edge 212A that is away from the flexible panel 100 (i.e., toward the heat sink 400) and a second edge 212B that is close to the flexible panel 100 (i.e., away from the heat sink 400). The first edge 212A has the first width W1, the second edge 212B has a second width W2, and the first width W1 is less than the second width W2. For example, the first width W1 may be the minimum width of the first edge 212A in the first direction D1, and the second width W2 may be the maximum width of the second edge 212B in the first direction D1, but the present disclosure does not limited thereto. In some embodiments, the ratio of the second width W2 to the first width W1 may be greater than 1 and less than or equal to 2 (1<W2/W1≤2).

As shown in FIG. 15, in some embodiments, the edge parts 212 may have a substantially inverted trapezoidal cross-sectional profile in a cross-sectional view. For example, the ratio of the area of the edge parts 212 facing the flexible panel 100 to the area of the edge parts 212 facing the heat sink 400 may be greater than 1 and less than or equal to 2. However, this disclosure is not limited thereto. It should be understood that, although the sidewalls of the non-foldable portion 202 and the edge parts 212 are shown as straight lines in this embodiment, the sidewalls of the non-foldable portion 202 and the edge parts 212 may be any regular or irregular shape (for example, curved or rough patterns) due to process variations. Any of the shapes are acceptable and fall within the scope of the present disclosure. With the above features, the adhesive ability between the supporting sheet 200 and the flexible panel 100 may be increased, and the adhesive ability between the supporting sheet 200 and the heat sink 400 may be reduced. As a result, the heat sink 400 tends to be partially separated from the supporting sheet 200 in the folded state, thereby releasing the stress between the heat sink 400 and the supporting sheet 200. As such, the negative impact from the stress on the flexible panel 100 may be reduced, or the overall yield of the electronic device 10 may be improved.

FIG. 16 shows a partial cross-sectional view of the electronic device 10 in accordance with some embodiments of the present disclosure. FIG. 16 shows a portion of the electronic device 10 in a folded state. In some embodiments, the heat sink 400 may have a separation portion 401 that is separated from the supporting sheet 200 (such as the edge parts 212) in a folded state, so as to relieve the stress between the heat sink 400 and the supporting sheet 200. In addition, in some embodiments, the width of the separation portion 401 in the first direction D1 may correspond to a plurality of edge parts 212. In other words, when the electronic device 10 is in the unfolded state, the separation portion 401 may at least partially overlap the edge parts 212 in the third direction D3. In some embodiments, the width of the separation portion 401 may correspond to five edge parts 212, but the present disclosure is not limited thereto. Any suitable number of edge parts 212 which the separation portion 401 corresponds is included within the scope of the present disclosure.

In some embodiments, in the folded state, the adhesive layer 300 may remain on the supporting sheet 200 and be separated from the heat sink 400. In other embodiments, in the folded state, the adhesive layer 300 may remain on the heat sink 400 and be separated from the supporting sheet 200. In still other embodiments, in the folded state, the adhesive layer 300 may partially remain on the supporting sheet 200 and the heat sink 400, respectively. The above embodiments may depend on the material properties of the supporting sheet 200, the adhesive layer 300 and the heat sink 400, and those skilled in the art may select any of the embodiments as required, and these embodiments are all covered within the scope of the present disclosure.

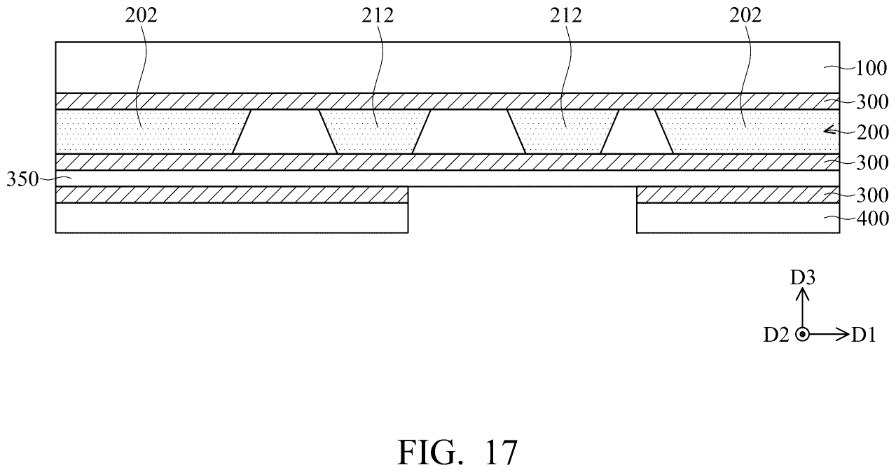

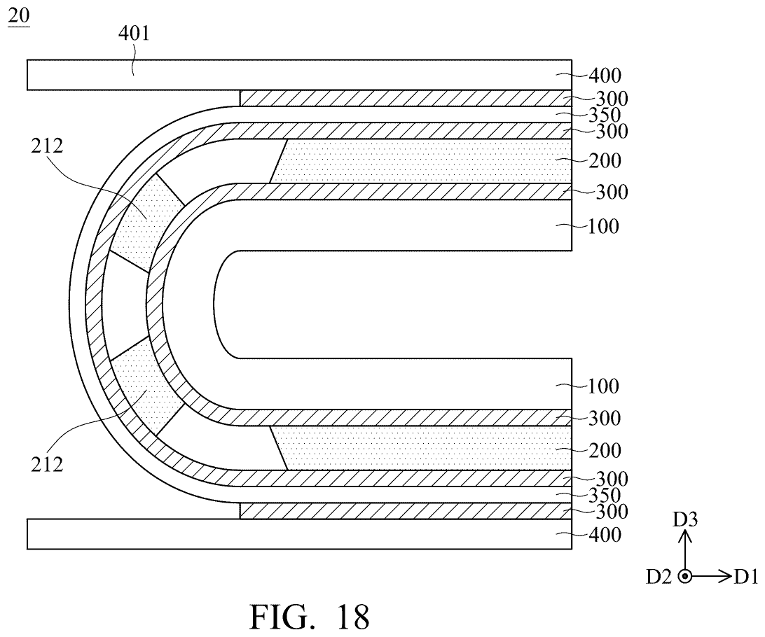

Referring to FIG. 17 and FIG. 18, FIG. 17 is a partial cross-sectional view of an electronic device 20 in accordance with some embodiments of the present disclosure. It should be noted that the electronic device 20 shown in this embodiment may include the same or similar parts as the electronic device 10 shown in FIG. 15. These parts will be denoted by the same or similar reference numerals and will not be described in detail below. For example, the electronic device 20 includes a flexible panel 100, a supporting sheet 200, adhesive layers 300 and a heat sink 400. The difference between the electronic device 20 in this embodiment and the electronic device 10 shown in FIG. 15 is that the electronic device 20 may further include a base layer 350, and the base layer 350 may be located between the opposite adhesive layers 300. The base layer 350 may not have any adhesiveness, and form a double-sided adhesive structure with the adhesive layers 300. In some embodiments, the adhesive layer 300 is not disposed on a position of the base layer 350 that is exposed to the heat sink 400. Although the base layer 350 is disposed between the supporting sheet 200 and the heat sink 400 in this embodiment, it should be noted that the adhesive structure formed by the base layer 350 and the adhesive layers 300 may be adopted to any suitable position in the electronic device 20. For example, the adhesive structure may be disposed between the supporting sheet 200 and the flexible panel 100. Not all possible embodiments will be listed below, and any embodiments including the base layer 350 are included within the scope of the present disclosure.

FIG. 18 shows a partial cross-sectional view of the electronic device 20 in accordance with some embodiments of the present disclosure. As shown in FIG. 18, the separation portion 401 may correspond to a position on the base layer 350 where the adhesive layer 300 is not disposed. With the above features, it is easier to control the position where the adhesive layer 300 is not disposed. For example, the position of the adhesive layer 300 on the base layer 350 is pre-determined before assembly, which improves the ease of assembling the electronic device 20.

As set forth above, the embodiments of the present disclosure provide an electronic device including a flexible panel and a supporting sheet having a specific structure to support the flexible panel. By arranging the supporting sheet with the edge portion of a specific size, the ease of folding the electronic device may be improved, or the probability of permanent deformation or damage of the supporting sheet may be reduced, thereby prolonging the service life of the supporting sheet. In addition, the edge portion has edges with different widths, so that the heat sink may tend to be separated from the supporting sheet in the folded state, thereby relieving the stress between the heat sink and the supporting sheet. Accordingly, the negative impact on the flexible panel from the stress may be reduced, improving the overall yield of electronic devices.

While the embodiments and the advantages of the present disclosure have been described above, it should be understood that those skilled in the art may make various changes, substitutions, and alterations to the present disclosure without departing from the spirit and scope of the present disclosure. It should be noted that different embodiments may be arbitrarily combined as other embodiments as long as the combination conforms to the spirit of the present disclosure. In addition, the scope of the present disclosure is not limited to the processes, machines, manufacture, composition, devices, methods and steps in the specific embodiments described in the specification. Those skilled in the art may understand existing or developing processes, machines, manufacture, compositions, devices, methods and steps from some embodiments of the present disclosure. Therefore, the scope of the present disclosure includes the aforementioned processes, machines, manufacture, composition, devices, methods, and steps. Furthermore, each of the appended claims constructs an individual embodiment, and the scope of the present disclosure also includes every combination of the appended claims and embodiments.

What is claimed is:

1. An electronic device, comprising:
a flexible panel having a foldable region and a non-foldable region, wherein the foldable region has a folding axis;
a supporting sheet disposed under the flexible panel and comprising a foldable portion, wherein the foldable portion overlaps the foldable region, and the foldable portion comprises:
a plurality of strip parts, wherein the strip parts are arranged in a first direction perpendicular to the folding axis; and
a plurality of edge parts, wherein each of the edge parts is connected to an end of at least two of the strip parts, and in a top view, a top end of the edge parts is not aligned with a top end of at least one portion of the non-foldable region; and
a heat sink disposed under the supporting sheet, comprising a gap and a separation portion adjacent to the gap,
wherein in a non-folded state, one of the edge parts overlaps the gap of the heat sink.

2. The electronic device as claimed in claim 1, wherein in a cross-sectional view, one of the edge parts has a substantially inverted trapezoidal cross-sectional profile.

3. The electronic device as claimed in claim 2, wherein the one of the edge parts has a first edge facing the heat sink and a second edge facing the flexible panel, and a width of the first edge is less than a width of the second edge.

4. The electronic device as claimed in claim 3, wherein a ratio of the width of the second edge to the width of the first edge is greater than 1 and less than or equal to 2

5. The electronic device as claimed in claim 2, wherein a distance between the edge parts gradually increases towards the heat sink.

6. The electronic device as claimed in claim 5, wherein a width of the gap is greater than a sum of a width of the one of the edge parts and the distance between the edge parts.

7. The electronic device as claimed in claim 1, further comprising:
a first adhesive layer disposed between the supporting sheet and the heat sink.

8. The electronic device as claimed in claim 7, wherein the first adhesive layer is disposed continuously across the edge parts.

9. The electronic device as claimed in claim 7, wherein in the non-folded state, the gap of the heat sink exposed a portion the first adhesive layer.

10. The electronic device as claimed in claim 7, further comprising:
a second adhesive layer disposed between the flexible panel and the supporting sheet.

11. The electronic device as claimed in claim 1, wherein the heat sink comprises an additional separation portion, and the gap is located between the separation portion and the additional separation portion in the non-folded state.

12. The electronic device as claimed in claim 11, wherein in a folded state, the separation portion is substantially parallel to the additional separation portion.

13. The electronic device as claimed in claim 12, wherein in the folded state, the flexible panel is located between the separation portion and the additional separation portion in a normal direction of the separation portion.

14. The electronic device as claimed in claim 1, wherein in a folded state, the gap laterally overlaps the edge parts and the flexible panel in a direction perpendicular to a normal direction of the separation portion.

15. The electronic device as claimed in claim 1, wherein the supporting sheet comprises a non-foldable portion adjacent to the foldable portion, and the non-foldable portion comprises a first inclined sidewall facing the foldable portion.

16. The electronic device as claimed in claim 15, further comprising:
an adhesive layer disposed continuously across the foldable portion and the non-foldable portion.

17. The electronic device as claimed in claim 15, wherein the one of the edge parts comprises a second inclined sidewall facing the non-foldable portion.

18. The electronic device as claimed in claim 17, wherein an extending direction of the first inclined sidewall is different from an extending direction of the second inclined sidewall.

19. The electronic device as claimed in claim 17, wherein a spacing between the first inclined sidewall and the second inclined sidewall increases towards the heat sink.

20. The electronic device as claimed in claim 15, wherein in the non-folded state, the non-foldable portion overlaps the separation portion.
